(19) United States
(12) Patent Application Publication
(10) Pub. No.: US 2017/0096053 A1
(43) Pub. Date: Apr. 6, 2017

(54) DOOR MODULE FOR INSTALLATION INTO A MOTOR VEHICLE DOOR

(71) Applicant: Brose Schliesssysteme GmbH & Co. KG, Wuppertal (DE)

(72) Inventors: Rene Faust, Dorsten (DE); Dirk Leve, Neuss (DE)

(21) Appl. No.: 15/281,660

(22) Filed: Sep. 30, 2016

(30) Foreign Application Priority Data
Oct. 2, 2015 (DE) 20 2015 105 205.7

(51) Int. Cl. B60J 5/04; E05D 15/16

(52) U.S. Cl. CPC B60J 5/0416; E05D 15/165; B60J 5/0418; B60J 5/0402; E05Y 2900/55

(57) ABSTRACT

The invention relates to a door module for installation into a motor vehicle door, wherein the door module has a lock receptacle for a motor vehicle lock and has a window guide rail for guiding a window pane which can be raised and lowered. It is proposed that the door module has a supporting structure comprising at least one supporting element in the region of the lock receptacle, and that, in the installed state, a lateral load on the window guide rail by the window pane along its pane surface can be at least partially supported by means of the supporting element at a supporting surface of an internal door panel of the motor vehicle door by way of a supporting force past the motor vehicle lock.

### CLAIM OF PRIORITY

This application claims the benefit of German Patent Application No. DE 20 2015 105 205.7, filed Oct. 2, 2015, the disclosure of which is incorporated by reference herein in its entirety.

### FIELD OF THE TECHNOLOGY

The present application relates to a door module for installation into a motor vehicle door, and also to a motor vehicle door comprising a door module of this kind.

### BACKGROUND

Different designs of the door module under discussion are known from the prior art. All door modules share the common feature that they accommodate at least one functional unit of the motor vehicle door. The door module is fitted with the functional units during preliminary assembly, so that the door module can be installed into the motor vehicle door together with the pre-mounted functional units. This procedure has gained popularity in recent years for the purpose of increasing efficiency when mounting motor vehicle doors.

The known door module (DE 20 2009 011 302 U1), on which the invention is based, likewise serves to receive functional units, specifically a motor vehicle lock and a bearing bracket, during preliminary assembly. The door module is further equipped with a window guide rail which provides only one side of a two-sided window guide.

On account of the high forces which occur when raising and lowering the window pane which is guided in the window guide rail, the window guide rail is subject to high mechanical loads and the components involved are usually also subject to a certain degree of elastic deformation. This results in particular requirements being made in respect of securing the window guide rail to the motor vehicle door. In the case of the known door module, the window guide rail is secured to the motor vehicle door, inter alia, by a screw boss. In particular, it is possible to support a lateral load on the window guide rail along the window surface and transverse to the longitudinal extent of the window guide rail only to a limited extent here. A lateral load of this kind often originates from a tendency of the window pane to tilt about a tilting axis which is oriented perpendicular to the pane surface. Inadequate support can easily lead to the window pane being trapped in the window guide rail, this having an adverse effect on the operational reliability of the motor vehicle door overall.

### SUMMARY

The application is based on the problem of designing and developing the known door module for installation into a motor vehicle door in such a way that the operational reliability of the motor vehicle door can be increased using simple means.

An aspect is the fundamental consideration that the characteristics of the installation situation of the motor vehicle lock can be used in order to better support a lateral load on the window guide rail, which lateral load is caused by the window pane.

In the present sense, the lateral load on the window guide rail is oriented along the pane surface of the window pane and has at least one component substantially perpendicular to the longitudinal extent of the window guide rail. This lateral load can be oriented substantially transverse to the longitudinal extent of the window guide rail. Here, the term “substantially” takes into account the fact that the longitudinal extent of the window guide strip is not necessarily exactly straight.

Specifically, it has been identified that the motor vehicle lock is fastened to a region of the internal door panel of the motor vehicle door which has a high level of mechanical stability, so that this region of the internal door panel is particularly well-suited to supporting the window guide rail. Furthermore, it has been identified that the region of the lock receptacle necessarily has to be arranged in the immediate vicinity of the abovementioned stable region of the internal door panel. Finally, it has been identified that it is readily possible to conduct the force flow of the supporting force past the motor vehicle lock, so that mechanically sensitive parts of the motor vehicle lock, in particular an electrical component carrier or the like of the motor vehicle lock, remains uninfluenced by the supporting force.

Specifically, it is proposed that the door module has a supporting structure comprising at least one supporting element in the region of the lock receptacle, wherein, in the installed state, a lateral load on the window guide rail by the window pane along its pane surface can be at least partially supported by means of the supporting element at a supporting surface of an internal door panel of the motor vehicle door by way of a supporting force, the force flow of the said supporting force running past the motor vehicle lock.

As a result, the installation situation of the motor vehicle lock is used in an optimum manner for supporting the window guide rail, wherein, for the purpose of compact and structurally simple implementation, components of the lock receptacle can be used for two purposes. It is proposed that these advantages can be realized without the motor vehicle lock itself being influenced by the force flow of the supporting force.

According to an embodiment, the supporting force under discussion here extends substantially in the longitudinal direction of the motor vehicle door. The longitudinal direction extends substantially transverse to the raising and lowering movement direction of the window pane. As a result, it is clear that the proposed support effectively counteracts the abovementioned jamming of the window pane.

In an embodiment, the lock receptacle itself provides the proposed supporting structure. This double use of the lock receptacle, specifically firstly to receive the motor vehicle lock and secondly to support the window guide rail, leads to compact and simple structural implementation.

According to an embodiment, one example of the abovementioned double use is that a receptacle element, in particular a receptacle rail, of the lock receptacle provides the supporting element of the supporting structure. Since a receptacle rail is generally an elongate element, the supporting force can run in the longitudinal direction of the receptacle rail given a suitable design.

According to an embodiment, rattling protection in order to prevent rattling noises which can originate from the engagement of the supporting element with the supporting surface can be achieved in that the engagement surface of the supporting element is equipped with at least one layer which is composed of damping material. Numerous advantageous variants, which are designed for the purpose of cost-effective manufacturability in particular, are feasible for the design of the damping material.

As an alternative or in addition, it can be provided that, in the absence of an abovementioned, lateral load on the window guide rail, a gap remains between the supporting structure and the supporting surface. In this respect, it is assumed that, overall, there is a certain degree of elasticity of the door module which ensures that after discontinuation of the lateral load on the window guide rail which accompanies force-fitting engagement between the supporting structure and the supporting surface, this is accompanied by elastic resetting of the door module and therefore the abovementioned gap being generated.

Once again as an alternative or in addition, it can be provided according to an embodiment that the supporting structure and the supporting surface are in constant engagement with one another. To this end, the supporting structure is equipped with a spring-compression region. It should be noted that it can additionally be provided that at least one further section of the supporting structure has an abovementioned gap which, in the event of a lateral load on the window guide rail, is closed as stated above, so that the proposed support can be provided.

The proposed motor vehicle door has an internal door panel to which an external door skin is fastened. The motor vehicle door further has a proposed door module which is fastened to the internal door panel. Reference may be made to all of the explanations relating to the proposed door module which are suitable for describing the motor vehicle door overall.

An embodiment provides a door module for installation into a motor vehicle door, wherein the door module has a lock receptacle for a motor vehicle lock and has a window guide rail for guiding a window pane which can be raised and lowered, wherein the door module has a supporting structure comprising at least one supporting element in the region of the lock receptacle, and in that, in the installed state, a lateral load on the window guide rail by the window pane along its pane surface can be at least partially supported by means of the supporting element at a supporting surface of an internal door panel of the motor vehicle door by way of a supporting force past the motor vehicle lock.

In an embodiment, the motor vehicle door extends between a front end surface and a rear end surface in a longitudinal direction, and in that the supporting force has a force component in the longitudinal direction of the motor vehicle door, such as the supporting force runs substantially in the longitudinal direction of the motor vehicle door.

In an embodiment, the lock receptacle provides the supporting structure or merges with the supporting structure, in particular in an integral manner.

In an embodiment, the lock receptacle has at least one receptacle element, in particular at least one receptacle rail, for, in particular, latching engagement with the motor vehicle lock, and in that the receptacle element or an extension of the receptacle element provides the supporting element of the supporting structure.

In an embodiment, at least one section of the door module is designed as an integral plastic part, such as at least one main body of the window guide rail and the lock receptacle are designed together with a carrying structure as an integral plastic part.

In an embodiment, in the installed state, the motor vehicle lock engages with a mounting surface of an end surface of the motor vehicle door, in particular by means of a locking plate, and in that the end surface provides the supporting surface for the supporting structure, such as at a surface which adjoins the mounting surface provides the supporting surface.

In an embodiment, at least one layer which is composed of damping material, such as of a textile material, of a plastic material, of a rubber material or the like, is provided on the engagement surface of the supporting element for the supporting engagement with the supporting surface.

In an embodiment, without a lateral load on the window guide rail by the window pane, a gap remains between the supporting structure and the supporting surface, and in that force-fitting engagement between the supporting structure and the supporting surface can be established by a lateral load on the window guide rail with the gap being closed.

In an embodiment, the window pane, in the fully raised state, is disengaged from the window guide rail or is in engagement with the window guide rail only by way of an end section of the window guide rail and as a result a gap remains between the supporting structure and the supporting surface.

In an embodiment, the supporting structure and the supporting surface are in constant, in particular force-fitting, engagement with one another, and in that the door module has a spring-compression region of spring-elastic flexibility for this purpose.

In an embodiment, the supporting element of the supporting structure comprises the spring-compression region, such that the spring-compression region provides the engagement surface of the supporting structure for supporting engagement with the supporting surface.

In an embodiment, the spring-compression region is designed as a buffer which is composed of a spring-elastic material, in particular of a rubber material, a plastic material or the like.

An embodiment provides a motor vehicle door comprising an internal door panel and comprising a door module, wherein the door module has a lock receptacle for a motor vehicle lock and has a window guide rail for guiding a window pane which can be raised and lowered, wherein the door module has a supporting structure comprising at least one supporting element in the region of the lock receptacle, and in that a lateral load on the window guide rail by the window pane along its pane surface can be at least partially supported by means of the supporting element at a supporting surface of an internal door panel of the motor vehicle door by way of a supporting force past the motor vehicle lock.

An embodiment provides a motor vehicle door as described herein with the a door module as described herein.

### BRIEF DESCRIPTION OF THE FIGURES

The invention will be explained in greater detail below with reference to a drawing which merely represents exemplary embodiments. In the drawing,

FIG. 1 shows a perspective view of a proposed motor vehicle door comprising a proposed door module according to a first embodiment in a partially mounted state,

FIG. 2 shows, in each case, a side view of the motor vehicle door according to FIG. 1 in the partially mounted state a) with the window pane fully raised and b) with the window pane fully lowered, and

FIG. 3 shows a proposed motor vehicle door comprising a proposed door module according to a further embodiment in the views according to FIG. 2.

The proposed door module 1 is intended to be installed in a motor vehicle door 2. In the present case, the term “motor vehicle door” is intended to be understood in broad terms. It comprises side doors, rear doors, rear covers, rear hatches, engine hoods or the like.

The door module 1 is primarily allocated two functions. Firstly, the door module 1 serves as a pre-mounting aid, as described in the introductory part of the description. Secondly, the door module 1 serves to secure at least one functional unit in the installed state, as will be explained further.

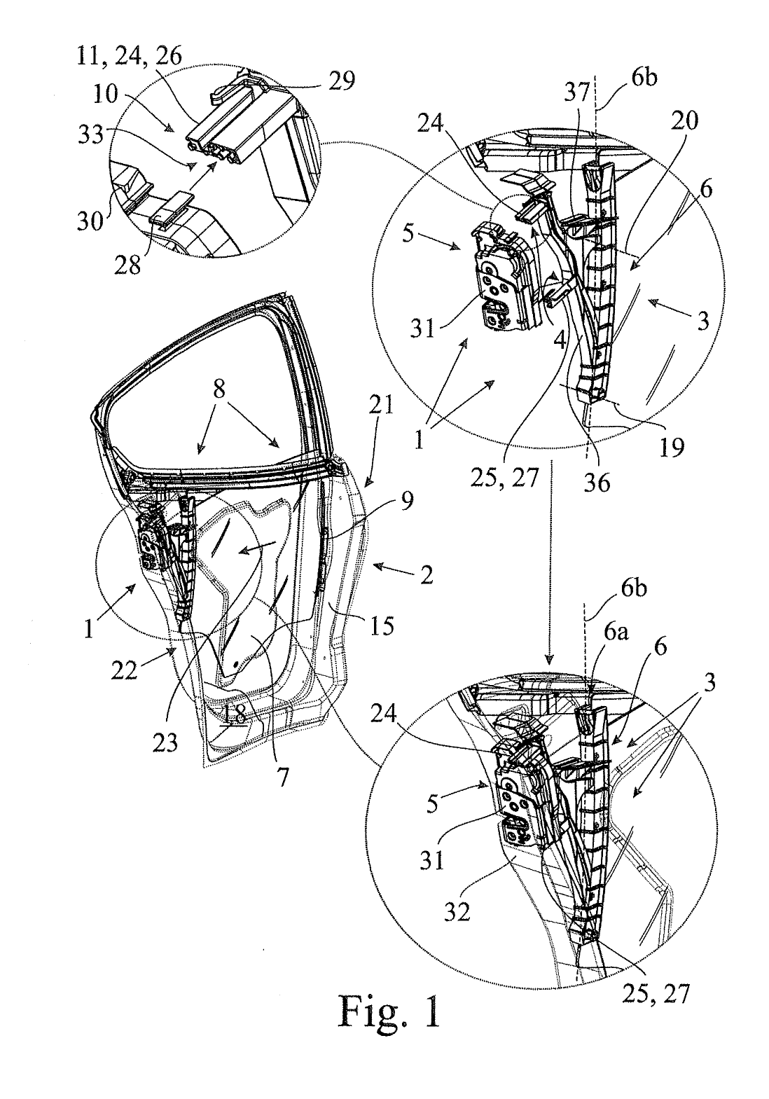

It can be seen most clearly from the illustration according to FIG. 1 that the door module 1 has a carrier structure 3, a lock receptacle 4 for a motor vehicle lock 5, and a window guide rail 6 for guiding a window pane 7 which can be raised and can be lowered. The window guide rail 6 provides a window guide channel 6a in which the window pane 7 runs. The window guide rail 6 provides only one side of a two-sided window guide 8 for the window pane 7. A further window guide rail 9, which is merely indicated in the drawing and plays a subordinate role for the proposed solution, is accordingly provided on the other side of the window pane 7. Here, the carrier structure 3 ensures a mechanical connection between the window guide rail 6 and the lock receptacle 4.

The window guide 8 guides the window pane 7 by means of the two window guide rails 6, 9 firstly in a lateral direction along the pane surface 7a of the window pane 7 and secondly in a transverse direction perpendicular to the pane surface 7a of the window pane 7.

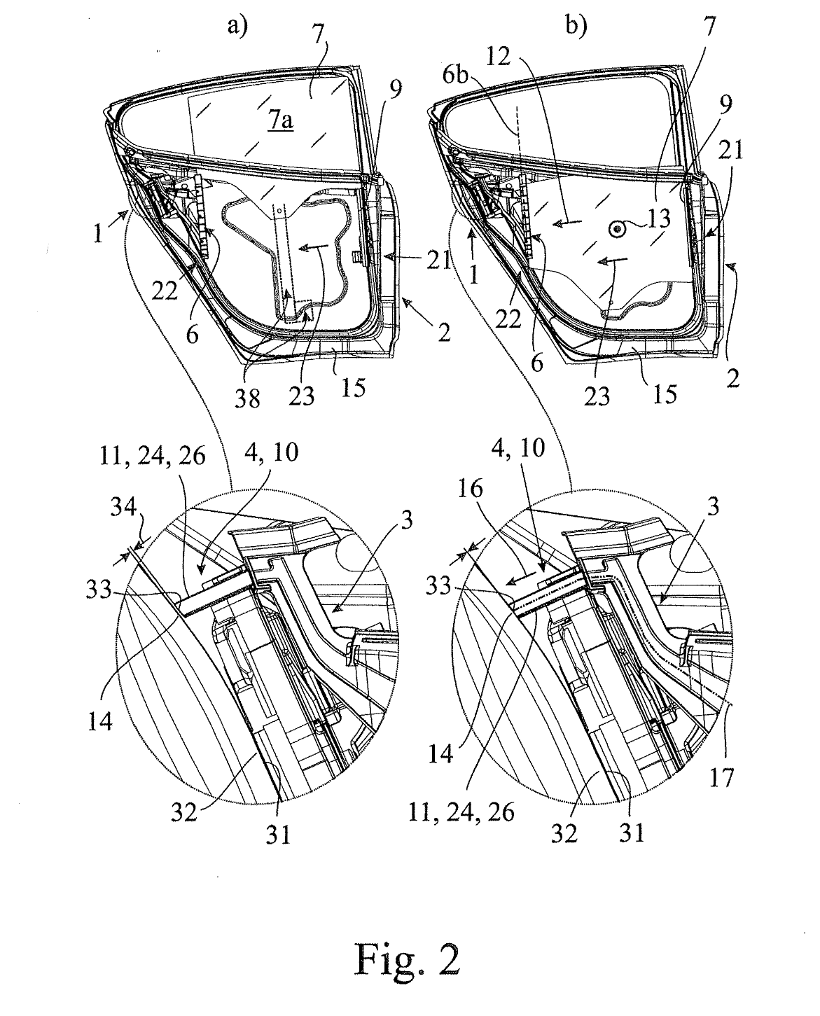

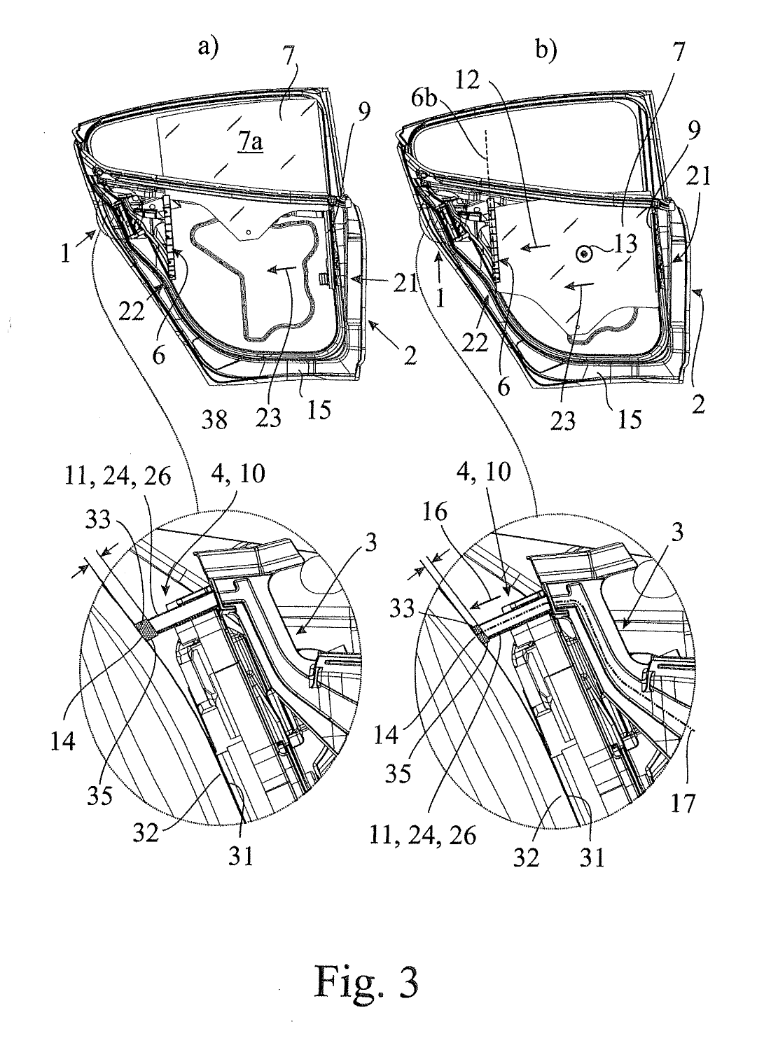

It is proposed that the door module 3 has a supporting structure 10 comprising at least one supporting element 11, here precisely one supporting element 11, in the region of the lock receptacle 4. The supporting element 11 is shown in the view of a detail arranged at the top left in FIG. 1.

Whereas the window guide rail 6 in FIG. 2a is largely not subjected to any load in the case of the fully raised window pane 7, a lateral load on the window guide rail 6 is produced by the fully lowered window pane 7 along its pane surface 7a according to FIG. 2b. The direction of this lateral load is indicated by reference symbol 12 in FIGS. 2b and 3b. The lateral load on the window guide rail 6 in the present sense is, as stated above, a load along the pane surface 7a and, here, substantially at least in a component transverse to the longitudinal extent 6b of the window guide rail 6, wherein this lateral load is applied to the window guide rail 6 by the window pane 7. A corresponding load in the opposite direction can be expected on the further window guide rail 9, but this is not relevant in the present case.

The abovementioned lateral load on the window guide rail 6 primarily originates from a tendency of the window pane 7 to tilt during adjustment of the window about a tilting axis 13 which is oriented substantially perpendicular to the pane surface 7a. This tendency to tilt is primarily the result of non-uniform guidance of the window pane 7 by the two window guide rails 6, 9 which, for its part, can originate from manufacturing tolerances, wear, soiling or the like.

It is important that the lateral load on the window guide rail 6 can be supported by the window pane 7 along its pane surface 7a at least partially by means of the supporting element 11 at a supporting surface 14 of an internal door panel 15 of the motor vehicle door 2 by way of a supporting force 16 past the motor vehicle lock 5. This means that the force flow 17 of the supporting force 16 runs past the motor vehicle lock 5. This can also comprises an arrangement in which the force flow runs past the motor vehicle lock 5 and is introduced into a flange plate, which is connected to the internal door panel 15, for the motor vehicle lock 5, this not being accompanied by a mechanical load on the lock components. The supporting engagement between the supporting element 11 and the supporting surface 14 can be seen in each of the illustrations of a detail in FIG. 2b and FIG. 3b.

The force flow 17 which runs across the door module 1 is indicated by a dashed line in FIG. 2b and FIG. 3b. Here, it is particularly important that the force flow 17 of the supporting force 16 runs past the motor vehicle lock 5. Negligible influences, such as friction or the like, have been disregarded here. These illustrations show that the motor vehicle lock 5 is not mechanically loaded by the supporting force 16.

In addition to the internal door panel 15, the motor vehicle door 2 has an external door skin 18, which is merely indicated in FIG. 1.

It has already been noted that the door module 1 can be designed for receiving entirely different functional units to the motor vehicle lock 5. Functional units of this kind can also be, for example, the bearing bracket of an external door handle, an internal door handle, a window winder or the like.

The door module 1 can be fastened to the internal door panel 15 in a variety of ways. Here, the window guide rail 6 and therefore the entire door module 1 is fastened to the internal door panel 15 by means of two screw bosses, the respective longitudinal extent 19, 20 of the said screw bosses being merely indicated in FIG. 1. Although mounting of the door module 1 on the internal door panel 15 is determined in this way, lowering the window pane 7 results in an elastic deformation of parts of the door module 1 on account of the high forces acting there, so that the proposed support of the window guide rail 6 comes into effect.

FIG. 1 shows that the proposed motor vehicle door 2 extends between a front end surface 21 and a rear end surface 22 in a longitudinal direction 23, wherein the supporting force 16 has at least one force component in the longitudinal direction 23 of the motor vehicle door 2. This is shown in the illustrations according to FIG. 2 and FIG. 3. In an embodiment, the supporting force 16 runs substantially in the longitudinal direction 23 of the motor vehicle door 2 overall.

The rear end surface 22 of the motor vehicle door 2, which is formed by the internal door panel 15, runs substantially transverse to the outer door skin 18 at least in sections in any case. This is illustrated in FIG. 2. Here, a hinge arrangement for pivoting the motor vehicle door 2 is arranged at the front end surface 21, while the abovementioned motor vehicle lock 5 is arranged at the rear end surface 22.

FIG. 1 further shows that the lock receptacle 4 itself provides the supporting structure 10. However, it is also feasible for the lock receptacle 4 to merge with the supporting structure 10, in particular in an integral manner.

Specifically, the lock receptacle 4 has at least one receptacle element 24, 25, here two receptacle elements 24, 25, for retaining engagement with the motor vehicle lock 5. Here, the receptacle elements 24, 25 very generally each comprise a receptacle rail 26, 27. The receptacle elements 24, 25, here the receptacle rails 26, 27, serve, as indicated above, for retaining engagement with the motor vehicle lock 5. The receptacle element 24 which is at the top in FIG. 1, that is to say the top receptacle rail 26, is at the front in the present case.

The motor vehicle lock 5 has a driver element 28 which can be brought into retaining engagement with the receptacle element 24, here with the receptacle rail 26. This produces a tongue-and-groove connection between the motor vehicle lock 5 and the door module 1 in the present case. In addition, the receptacle element 24 is equipped with a latching arrangement, here a latching hook 29, which interacts with a latching protrusion 30 on the motor vehicle lock 5 in order to establish latching engagement. The receptacle rail 26 can be oriented along the supporting force 16, so that decoupling between the motor vehicle lock 5 and the lock receptacle 4 takes place in the direction of the supporting force 16.

In the present case, it is particularly important that the receptacle element 24, here the receptacle rail 26, provides the supporting element 11 of the supporting structure 10 at the same time. In principle, it can also be provided that an extension of the receptacle element 24 provides the supporting element 11 of the supporting structure 10. Furthermore, it can be provided that, as an alternative or in addition, the further receptacle element 25 provides the supporting element 11 or a further supporting element of the supporting structure 10. FIG. 1 shows that no additional structural element has to be provided for realizing the supporting structure 10, so that the proposed solution, as explained above, allows a compact and simple structural design.

The door module 1 can be realized in a particularly cost-effective manner in that, here, at least one section of the door module 1 is designed as an integral plastic part. In this case, this at least one section of the door module 1 can further be produced using a plastic injection-moulding process. In an embodiment, the lock receptacle 4 is designed as an integral plastic part as such in any case. The carrying structure 3 can be designed as an integral plastic part together with the lock receptacle 4. In the illustrated and in this embodiment, at least one main body of the window guide rail 6, the carrying structure 3 and the lock receptacle 4 are together designed as an integral plastic part. If a plurality of integral plastic parts are provided, it can be provided that these plastic parts are coupled, in particular clipped or the like, to one another.

The arrangement of the supporting surface 14, by means of which the supporting force 16 is introduced into the internal door panel 15, is of very particular importance in the present case. In the installed state, the motor vehicle lock 5 can be in engagement with a mounting surface 32 of an end surface, here the rear end surface 22, of the motor vehicle door 2, here by means of a locking plate 31 of the motor vehicle lock 5, wherein this end surface 22 provides the supporting surface 14 for the supporting structure 10. As shown in the illustrations according to FIG. 2 and FIG. 3, a surface which adjoins the mounting surface 32 here provides the supporting surface 14. This is advantageous in as much as the mounting surface 32 has to be of mechanically stable design owing to the high retaining forces which are to be absorbed by the motor vehicle lock 5, it being possible to utilize this for the proposed support. The mounting surface 32 and the supporting surface 14 can have substantially the same orientation.

For the proposed support, the supporting element 11 further lies on the supporting surface 14, without additional measures for connection having been made. The force-fitting connection between the supporting element 11 and the supporting surface 14 is therefore possible solely on one side in this case. As a result, there is, in principle, the risk of rattling noises being produced when the lateral load on the window guide rail 6 is only low or there is no load at all. To this end, it can be provided that at least one layer, not illustrated, which is composed of damping material is provided on the engagement surface 33 of the supporting element 11 for supporting engagement with the supporting surface 14. Damping materials of this kind are used, for example, in the case of rattling, such as of a glove compartment, in order to prevent rattling noises. The damping material can be, for example, a textile material, in particular felt, a plastic material, a rubber material or the like. In principle, the at least one layer which is composed of damping material can also be moulded onto the supporting element 11 using a plastic injection-moulding process.

FIGS. 2 and 3 show different refinements of the proposed door module 1 in respect of the interaction of the supporting element 11 with the supporting surface 14.

In the refinement illustrated in FIG. 2, it is provided that a gap 34 remains between the supporting structure 10 and the supporting surface 14 without a lateral load on the window guide rail 6 (FIG. 2a). Force-fitting engagement between the supporting structure 10, here the supporting element 11, and the supporting surface 14 can be established (FIG. 2b) by a lateral load on the window guide rail 6, which is indicated by reference symbol 12 in FIG. 2b.

In view of the fact that the window pane 7 is disengaged from the window guide rail 6 in the fully raised state (FIG. 2a), a gap 34 remains between the supporting structure 10 and the supporting surface 14 in this state. It is clear from this that the supporting structure 10, here the supporting element 11, of the door module 1 illustrated in FIG. 2 should be equipped with at least one abovementioned layer, which is composed of a damping material, in an embodiment in order to prevent rattling noises being produced.

FIG. 3 shows a variant which is particularly robust in respect of preventing rattling noises. Here, the supporting structure 10 and the supporting surface 14 are in constant, force-fitting, engagement with one another. This can be gathered from looking at FIG. 3a, which shows the state without a lateral load on the window guide rail 6, and FIG. 3b, which shows the state with, in the present sense, a lateral load on the window guide rail 6.

For this constant force-fitting connection, the supporting structure 10, here the supporting element 11, is equipped with a spring-compression region 35 which exhibits spring-elastic flexibility in the supporting direction. The said spring-compression region can be designed such that the spring-compression region 35 can be compressed against its spring-elastic flexibility in the supporting direction. In the exemplary embodiment illustrated in FIG. 3, the spring-compression region 35 is always at least slightly compressed, this producing the resulting, constant force-fitting connection between the supporting structure 10 and the supporting surface 14.

The spring-compression region 35 of the supporting structure 10 can be arranged at entirely different points. Here, the supporting element 11 of the supporting structure 10 comprises the spring-compression region 35, as shown by the illustration according to FIG. 3. In an embodiment, the spring-compression region 35 also provides the engagement surface 33 of the supporting structure 10 for the supporting engagement with the supporting surface 14. The production of rattling noises is additionally countered as a result.

In principle, the spring-compression region 35 can lie at any point in the force flow 17 of the supporting force 16. By way of example, the spring-compression region 35 can be arranged at a distance from the supporting element 11 on the carrying structure 3, for example on the arms 36, 37 of the supporting structure 3 which are shown in FIG. 1. Very generally, it is feasible for the spring-compression region 35 to be realized by deliberate weakening of the carrying structure 3.

However, in the simplest case, the spring-compression region 35 is designed as a buffer which is composed of a spring-elastic material, here of a rubber material, of a plastic material or the like. In principle, it is once again feasible here for the buffer to be moulded onto the door module 1, using a plastic injection-moulding process. As an alternative, it can also be provided that the spring-compression region 35 is formed by a spring arrangement comprising a spring element or a plurality of spring elements.

Here, the window pane 7 can be adjusted by motor. To this end, a window winder drive 38 can be associated with the window pane 7. The window winder drive 38 can be of single-train design. This means that the window winder drive 38 introduces the drive force into the window pane 7 by means of a single drive train. Although this is cost-effective, it encourages the abovementioned inclination of the window pane 7 to tilt. In this respect, the proposed solution, which has a high degree of robustness with respect to an inclination to tilt of this kind, is particularly advantageous here. However, in principle, it can also be provided that the window winder drive 38 is of multi-train design and introduces the drive force into the window pane 7 by means of a plurality of drive trains.

According to a further teaching, which is of independent importance, a motor vehicle door 2 comprising an internal door panel 15 and comprising an abovementioned, proposed door module 1 can be described as such. Reference may be made to all statements relating to the proposed door module 1 which are suitable for explaining the motor vehicle door 2 as such.

1. A door module for installation into a motor vehicle door, wherein the door module has a lock receptacle for a motor vehicle lock and has a window guide rail for guiding a window pane which can be raised and lowered,
wherein the door module has a supporting structure comprising at least one supporting element in the region of the lock receptacle, and in that, in the installed state, a lateral load on the window guide rail by the window pane along its pane surface can be at least partially supported by the supporting element at a supporting surface of an internal door panel of the motor vehicle door by way of a supporting force past the motor vehicle lock.

2. The door module according to claim 1, wherein the motor vehicle door extends between a front end surface and a rear end surface in a longitudinal direction, and in that the supporting force has a force component in the longitudinal direction of the motor vehicle door.

3. The door module according to claim 1, wherein the lock receptacle provides the supporting structure or merges with the supporting structure.

4. The door module according to claim 1, wherein the lock receptacle has at least one receptacle element for latching engagement with the motor vehicle lock, and in that the receptacle element or an extension of the receptacle element provides the supporting element of the supporting structure.

5. The door module according to claim 1, wherein at least one section of the door module is designed as an integral plastic part.

6. The door module according to claim 1, wherein, in the installed state, the motor vehicle lock engages with a mounting surface of an end surface of the motor vehicle door.

7. The door module according to claim 1, wherein at least one layer which is composed of damping material is provided on the engagement surface of the supporting element for the supporting engagement with the supporting surface.

8. The door module according to claim 1, wherein, without a lateral load on the window guide rail by the window pane, a gap remains between the supporting structure and the supporting surface, and in that force-fitting engagement between the supporting structure and the supporting surface can be established by a lateral load on the window guide rail with the gap being closed.

9. The door module according to claim 8, wherein the window pane, in the fully raised state, is disengaged from the window guide rail or is in engagement with the window guide rail only by way of an end section of the window guide rail and as a result a gap remains between the supporting structure and the supporting surface.

10. The door module according to claim 1, wherein the supporting structure and the supporting surface are in constant engagement with one another, and in that the door module has a spring-compression region of spring-elastic flexibility for this purpose.

11. The door module according to claim 10, wherein the supporting element of the supporting structure comprises the spring-compression region.

12. The door module according to claim 10, wherein the spring-compression region is designed as a buffer which is composed of a spring-elastic material.

13. A motor vehicle door comprising an internal door panel and comprising a door module, wherein the door module has a lock receptacle for a motor vehicle lock and has a window guide rail for guiding a window pane which can be raised and lowered,
wherein the door module has a supporting structure comprising at least one supporting element in the region of the lock receptacle, and in that a lateral load on the window guide rail by the window pane along its pane surface can be at least partially supported by the supporting element at a supporting surface of an internal door panel of the motor vehicle door by way of a supporting force past the motor vehicle lock.

14. The motor vehicle door according to claim 13, characterized by the features of claim 1.

15. The door module according to claim 2, wherein the supporting force runs substantially in the longitudinal direction of the motor vehicle door.

16. The door module according to claim 5, wherein at least one main body of the window guide rail and the lock receptacle are designed together with a carrying structure as an integral plastic part.

17. The door module according to claim 6, wherein a surface which adjoins the mounting surface provides the supporting surface.

18. The door module according to claim 7, wherein the damping material is selected from a group consisting of: a textile material, a plastic material, or a rubber material.

19. The door module according to claim 11, wherein the spring-compression region provides the engagement surface of the supporting structure for supporting engagement with the supporting surface.

20. The door module according to claim 1, wherein the supporting structure and the supporting surface are in constant force-fitting engagement with one another, and in that the door module has a spring-compression region of spring-elastic flexibility for this purpose.
